(19) United States
(12) Patent Application Publication
(10) Pub. No.: US 2013/0103440 A1
(43) Pub. Date: Apr. 25, 2013

(54) METHOD AND SYSTEM FOR FINANCIAL MODELING OF RETROFITTING COST OF AN ENERGY SYSTEM

(71) Applicant: Behzad IMANI, San Mateo, CA (US)

(72) Inventor: Behzad IMANI, San Mateo, CA (US)

(21) Appl. No.: 13/278,848

(22) Filed: Oct. 21, 2011

(51) Int. Cl. G06Q 10/00

(52) U.S. Cl. 705/7.11

(57) ABSTRACT

A system and method for financial modeling of energy efficiency retrofitting cost of an energy system. According to the method, using a monitoring and evaluation system, signals from a number of sensors positioned in predetermined locations of a structure considered for energy efficiency retrofitting are received. The received signals are compared with benchmarks retrieved from a benchmark database. Using results of the comparison, one or more energy consuming components of the structure are identified as candidates for retrofitting. Based on a normalized payback time or other rate of return approach determined by using data retrieved from a retrofit-cost database, a financing model, in relation to an interest rate, for evaluating a cost of retrofitting the one or more component is provided.

### FIELD OF THE INVENTION

This invention relates generally to the field of energy management and more particularly to a computer-related method and system for financial modeling of building energy efficiency.

### BACKGROUND

As well known, buildings and structures use a large amount of energy (e.g., natural gas and electricity) for heating, ventilation and air-conditioning (HVAC), and other purposes. This is true of residential buildings, office buildings, commercial buildings, factories, and so on. Existing buildings and structures may suffer from a variety of inefficiencies and under-performances. These inefficiencies and under-performances may include, for example, simultaneous cooling and heating, inefficient cooling/heating, dead zones with almost no cooling/heating, simultaneous over-cooling/heating, under-cooling/heating in various zones of the building or structure, or uncontrolled and rapid deterioration of mechanical system components.

Mitigating these inefficiencies and under-performances may result in a significant reduction in energy consumption and maintenance cost of the affected buildings and structures. Many obstacles including financial cost of retrofitting such buildings and structures may play a role in precluding such an important reduction in wasteful energy consumption. Therefore, the present inventor has identified a need for a financial model that can facilitate retrofitting of existing buildings and structures.

### SUMMARY

Embodiments of a computer-based system and method for financial modeling of energy efficiency retrofitting cost of an energy system are provided. According to the method, using a monitoring and evaluation system, signals from a number of sensors positioned in predetermined locations of a structure considered for energy efficiency retrofitting are received. The received signals are compared with benchmarks retrieved from a benchmark database. Using results of the comparison, one or more energy consuming components of the structure are identified as candidates for retrofitting. A financing model for evaluating a cost of retrofitting of the one or more components in relation to a mortgage interest rate is provided, based on a normalized payback time determined by using data retrieved from a retrofit-cost database.

### BRIEF DESCRIPTION OF THE DRAWINGS

FIG. 1 is a high-level diagram illustrating an energy system, according to some embodiments.

FIG. 2 is a block diagram illustrating a system for financial modeling of energy efficiency retrofitting cost of the energy system of FIG. 1, according to some embodiments.

FIG. 3 is a block diagram illustrating a data structure of a benchmark database used in the system of FIG. 2, according to some embodiments.

FIG. 4 is a block diagram illustrating a data structure of a maintenance database used in the system of FIG. 2, according to some embodiments.

FIG. 5 is a flow diagram of a method for financial modeling of energy efficiency retrofitting cost of an energy system.

FIG. 6 is a block diagram of a computer system used in accordance with the present system.

### DETAILED DESCRIPTION

The description that follows includes exemplary systems, apparatuses, methods, and techniques that embody techniques of the present inventive subject matter. However, it is understood that the described embodiments may be practiced without these specific details.

According to an aspect, a method for financial modeling of energy efficiency retrofitting cost of an energy system may include using a monitoring and evaluation system, receiving signals from a plurality of sensors positioned in predetermined locations of a structure (e.g., the energy system) considered for energy efficiency retrofitting. An example of such sensors and the types of data they collect is disclosed in U.S. application Ser. No. 12/888,277, commonly invented, filed Sep. 22, 2010 “Method and Apparatus for Optimizing HVAC Systems in Buildings” incorporated by reference herein in its entirety. The received signals can be compared with benchmarks retrieved from a benchmark database. Using results of the comparison, one or more components of the structure may be identified as a candidate for retrofitting. Data retrieved from a retrofit-cost database may be used to determine normalized payback time, which is used to provide a financing model for evaluating a cost of energy efficiency retrofitting of one or more components of the energy system in relation to a mortgage interest rate.

In one aspect, a monitoring and evaluation system including a number of sensors positioned in predetermined locations of a structure considered for energy efficiency retrofitting may include a communication module coupled to a network and configured to receive signals from the plurality of sensors. The system may also include one or more processors coupled to a computer readable memory, where the memory may be configured to store the following: a benchmark database configured to store benchmarks; a comparison module, executable by the one or more processors, configured to compare the received signals with benchmarks retrieved from a benchmark database; an identification module, executable by the one or more processors, configured to identify, using results of the comparison, one or more components of the structure as a candidate for retrofitting; a retrofit-cost database configured to store information relating to retrofitting cost of a number of components; a modeling module, executable by the one or more processors, configured to provide a financing model for evaluating a cost of the retrofitting of the one or more components in relation to a mortgage or other interest rate, based on a normalized payback time or rate of return determined by using data retrieved from a retrofit-cost database.

In another aspect, a computer based monitoring and evaluation system includes a communications element for receiving signals from a plurality of sensors positioned in predetermined locations of a structure considered for energy efficiency retrofitting. The system also includes a processing element and a comparing element, executable by the processing element, for comparing the received signals with benchmarks retrieved from a benchmark database. An identifying element, executable by the processing element, can identify, using results of the comparison, at least one component of the structure as a candidate for retrofitting. The comparing element is executable by the processing element. A modeling element, executable by the processing element, can provide a financing model for evaluating a cost of the retrofitting of the at least one component in relation to a mortgage or other interest rate, based on a normalized payback time or rate of return determined by using data retrieved from a retrofit-cost database.

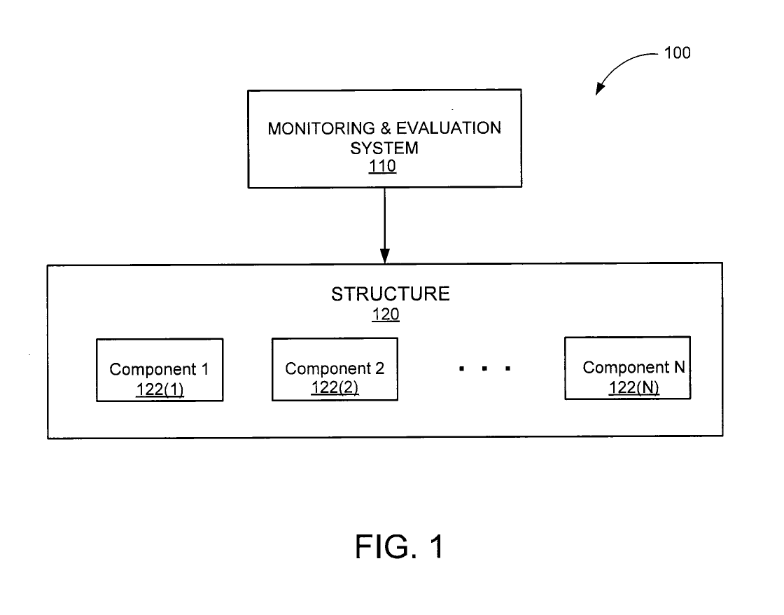

FIG. 1 is a high-level diagram illustrating an energy consuming system 100, according to some embodiments. The energy system 100 may include a monitoring and evaluation system (MES) 110, a structure 120 and a number N of components 122 (e.g., components 122(1)-122(n) each being a conventional HVAC system component). MES 110 may be configured to receive signals from a number of sensors positioned in predetermined locations of the structure 120 considered for energy efficiency retrofitting. MES 110 can compare the received signals with benchmarks retrieved from a benchmark database. MES 110 can identify, using results of the comparison, one or more components 122 of the structure 120 as a candidate for retrofitting. Further, MES 110 can provide a financing model for evaluating a retrofitting cost of the components 122 in relation to a mortgage (cost of funds) interest rate, based on e.g. a normalized payback time determined by using data retrieved from a retrofit-cost database or on some other measure such as internal rate of return.

Energy system 100 may, for example, include an energy management system, or an energy optimization system. Structure 120 may include, but is not limited to, a residential or commercial building (e.g., a mall, a department store, a bank, a restaurant, etc.), a factory, a refinery, a ship, a power plant, an off-shore facility, a manufacturing facility, and the like. The components 122 may be, but are not limited to, various zones of a building or facility, mechanical systems or devices, electrical systems, electromechanical systems, renewable energy conversion systems and the like.

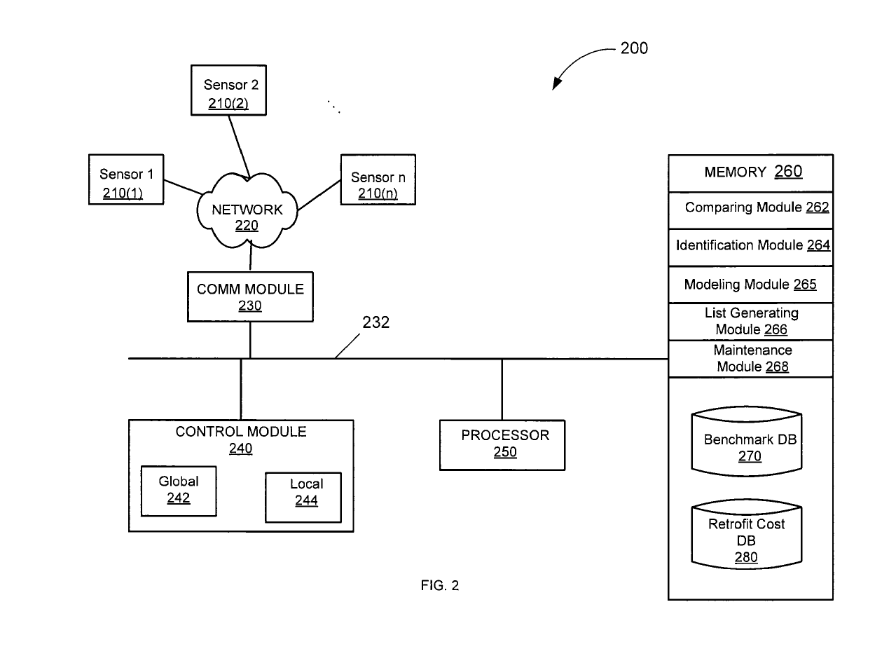

FIG. 2 is a block diagram illustrating a system 200 for financial modeling of energy efficiency retrofitting cost of the energy system 100 of FIG. 1, according to some embodiments. System 200 may include a network 220, a communication module 230, and a number n of sensors 210 (e.g., 210(1)-210(n), a control module 240, one or more processors 250, a memory 260, a benchmark database 270, and a retrofit database 280. Memory 260 may store a number of modules, for example, a comparing module 262, an identification module 264, a modeling module 265, a list generating module 266, and a maintenance module 268. Each of these modules may include hardware, software executable by the one or more processors 250, or firmware.

Sensors 210 and communication module 230 are linked via network 220 (e.g., the Internet, a local area network (LAN), a wide area network (WAN) or a metropolitan area network (MAN), etc.). Sensors 210 may be positioned in predetermined locations (e.g., various zones, various rooms, etc.) of structure 120 of FIG. 1 and sense a number of parameters, such as, temperature, pressure, humidity, air or liquid flow, entropy, enthalpy, and so on. Communication module 230 can receive signals from sensors 210 and communicate the signals via a bus 232 to control module 240, processor 250, or memory 260.

Control module 240 may include a global control module 242 and a local control module 244. Control module 240 can generate local and global control signals, using the global control module 242 and a local control module 244, to control operations of components 122 of FIG. 1. The control exerted by these signals may make each component 122 to operate at a predetermined percentage (e.g., greater than 90%) of its rating while maintaining a predetermined overall efficiency (e.g., greater than 60%) of the structure 120 of FIG. 1.

Comparison module 262 may be configured to compare the received signals from sensors 210 with benchmarks retrieved from a benchmark database 270. The result of the comparison is communicated to an identification module 264, which is configured to identify, using the results of the comparison, one or more components 122 of structure 120 that may be candidates for retrofitting. A modeling module 265, executable by the one or more processors 250, is configured to provide a financing model for evaluating a cost of the retrofitting of the candidate components 122 in relation to a mortgage interest rate, based on a normalized payback time. The normalized payback time may be determined by using data retrieved from a retrofit-cost database 280. Further details of the financial modeling are provided below.

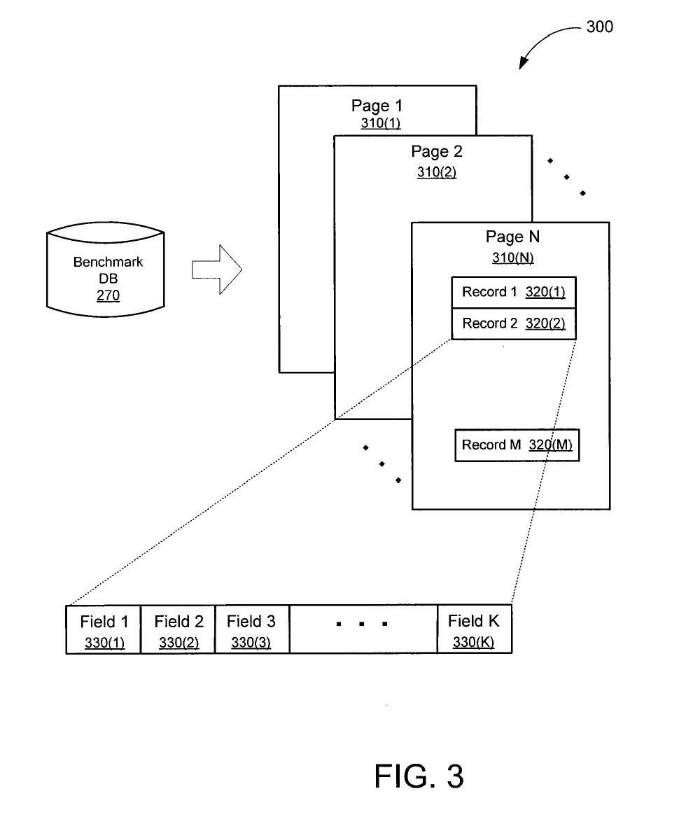

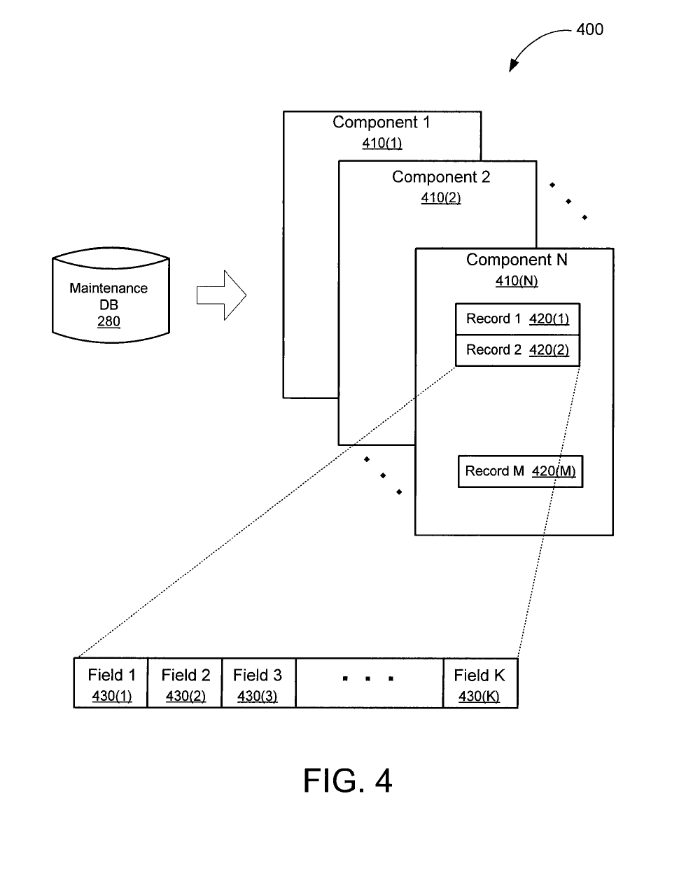

In some aspects, a list generator module 266 may be configured to facilitate non-energy related cost savings by generating a list of one or more malfunctioning or under-performing components, based on the signals received from the sensors 210. A maintenance module 268 may be configured to provide a maintenance schedule for the components in the list generated by the list generator module 266. The maintenance schedule may be provided such that the overall operation of the structure 120 is kept at a pinnacle of the energy efficiency of the structure 120. Retrofit-cost database (e.g., retrofit database) 280 may be configured to store information relating to retrofitting cost of the components 122, which were determined to be candidates for retrofitting. Benchmark database 280 is configured to store benchmarks relating to operational performance components 120. Data structure of benchmark database 270 and retrofit database 280 are discussed in more detail with respect to FIGS. 3 and 4 herein.

Referring back to modeling module 265, this module is further configured to provide a financing model for evaluating the cost of the retrofitting of the components 122 that were identified as candidates for retrofitting, in relation to a tax rate, based on the normalized payback time determined by using the data retrieved from the retrofit-cost database. For example, modeling module 265 may base its model on splitting the annual energy savings, on a 50-50 basis, with the building owners, while locking the energy prices fixed with a small (e.g., less than 3%) escalation. Modeling module 265 calculates a return of investment (ROI) on the 50/50 split from the following formula:

ROI=k*(total savings within a ten year period)/10*RC, (1)

where RC represents a retrofit cost, which for each component 122 may be retrieved from the retrofit database 280, and k is a parameter that can be a percentage (e.g., 25%). The total savings includes energy and non-energy related saving.

A normalized payback time may be calculated based on PBi, in months, for each retrofitted component 122(i):

PB=1/Σ(360/PBi) (2)

For example, for a 300,000 sq ft commercial building, the cost of energy retrofitting may be estimated as $350,000 or about $1.17 per Sq ft. After the completion of the retrofit project, an energy savings of 37 cents per sq ft per year may be achieved. Adding an example non-energy (maintenance and component repair and replacement) savings of 40 cents per sq ft per year, the total energy and non-energy savings sums up to 77 cents per sq ft per year. So dividing $1.17 by $0.77 (i.e., 77 cents) gives a payback time of about one year and six months and 7 days. In a 50/50 cost splitting basis, if a vendor assumes the initial retrofit cost of $350,000, and then splits the energy savings 50/50 between the vendor and the facility owner (e.g., owner of structure 120) for 10 years, the vendor can earn 0.5 (300,000 sq ft×$0.77×10)=$1,155,000 in ten years, which implies a ROI of about 16.5% on the initial retrofit expense, that is to say an interest rate of 16.5% on the original retrofit expense. It is also beneficial to the owner of the facility, because the owner also earns operational savings equivalent to a 16.5% (mortgage) interest rate on the retrofit expense that he does not have to pay for.

The vendor can package the cash flow from a number (e.g., 10 or more) of such energy savings projects and sell the financial package to investors (e.g., foreign or other companies or governments) at a fixed interest rate (e.g., 5%) for ten years to securitize cash flow from the present method. So the net profit from the system can, for example, be calculated from applying the net rate of 11.5% on the capital expense (e.g., $300,000).

The above calculation leading to, for example, a 16.5% interest rate over 10 years can become the basis for government legislation on the property tax deduction when a property undergoes energy retrofit. The same type of calculations can be used for a sustainability index report (i.e. the expected cost of operation) of a commercial building and facility before and after it goes through energy retrofit.

FIG. 3 is a block diagram illustrating a computer based data structure 300 of a benchmark database 270 used in system 200 of FIG. 2, according to some embodiments. Benchmark data base 270 may include a number N of pages 310 (e.g., pages 310(1)-310(N)), each including benchmark data relating to a component 122 of FIG. 1. Each page 310 may include a number M of data records 320 (e.g., data records 320(1)-320(M)). Each data record 320 may correspond to, for example, a performance characteristic determined by a specific test. Each data record 320 may include a number K of data fields 330 (e.g., data fields 330(1)-330(N)). Data fields 330 may, for example, specify a portion of the performance characteristic, for instance, an in-operation temperature, an in-operation pressure, a level of a liquid, such as oil, and the like.

FIG. 4 is a block diagram illustrating a data structure 400 of a computer based maintenance database 280 used in system 200 of FIG. 2, according to some embodiments. Maintenance data base 280 may include a number N of pages 410 (e.g., pages 410(1)-410(N)), each including retrofit cost data relating to a component 122 of FIG. 1. Each page 410 may include a number M of data records 420 (e.g., data records 420(1)-420(M)). Each data record 420 may correspond to, for example, a maintenance program for a specific part or subcomponent of the component 122. Each data record 420 may include a number K of data fields 430 (e.g., data fields 430(1)-430(N)). Data fields 430 may, for example, specify a portion of the maintenance program, for instance, a replacement of the part or subcomponent after a certain operation period, or a specific repair after another operation period and the like.

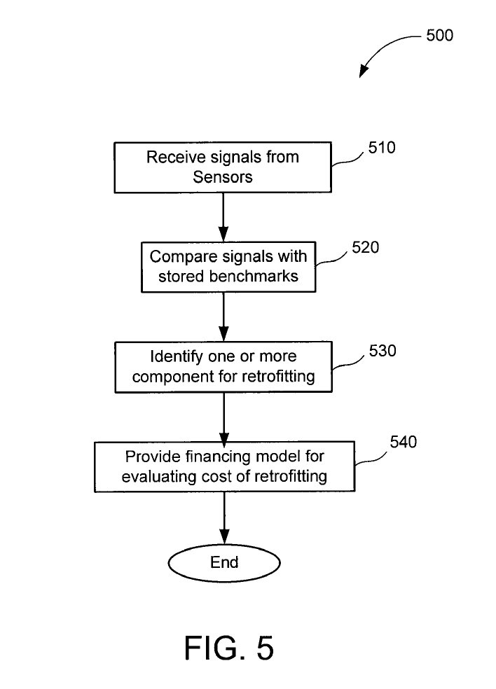

FIG. 5 is a flow diagram of a method 500 for financial modeling of energy efficiency retrofitting cost of an energy system. Method 500 includes receiving by communication module 230 of FIG. 2, via network 220 of FIG. 2, signal from sensors 210 of FIG. 2 positioned in various locations of structure 120 of FIG. 1 (510). Signals received from sensors 210 may be compared, by comparing module 262 of FIG. 2, with benchmarks retrieved from benchmark database 270 of FIG. 1 (520). Identification module 264 of FIG. 2 may identify a number of components 122 of FIG. 1 as candidates for retrofitting (530). Modeling module 265 of FIG. 2 may provide a financing model for evaluating cost of retrofitting of the candidate component 122 in relation to a mortgage interest rate, based on a normalized payback time determined by using data retrieved from a retrofit-cost database 280 of FIG. 2 (540).

Some other aspects of the current disclosure may include applying optimizations monitor, control HVAC systems, complex mechanical systems such as boilers, hot water generations, chillers, space cooling and space heating systems, geothermal systems, chill beams, radiant panels as well as solar hot water, solar co-generations, and water treatments in commercial buildings. Moreover, the disclosed models can be applied to massive cooling and heating systems in district cooling and district heating for down towns and joint commercial and apartment campuses.

Disclosed models may be desirable for high load infrastructures such as refineries, mass bio-fuel systems, and any other any conversion system. The goal is to analyze and model the heat flow characteristics within the systems with thermodynamic, fluid mechanics, computational fluid dynamics (CFD), comprehensible fluid, and multi-phased CFDs, and establish trend data at the critical junctions within the system, and then control the entire system. For example, the old enthalpy charts may be replaced with detailed analytical techniques.

Many commercial buildings are not operating at their optimum energy state. Even if they do, HVAC systems in buildings may “drift” within 3 years from their optimum energy operations state. Moreover, even if they operate in an optimum energy state, one or more or all of their components may drift such that the faulty component can result in malfunction of the rest of the system. Thereby, the efficiency may decrease substantially. Energy savings in commercial buildings may be provided via auto commissioning, retro commissioning, or open commissioning of the HVAC system using state of the art fluid dynamic techniques.

In the past 40 years, the energy prices have elevated at an annual rate of about 7% per year in California. A onetime tune up of buildings may be performed to keep the building tuned-up over time using software as a service (SaaS) based building energy management system. The business proposition may include using SaaS for optimizing the HVAC systems of commercial buildings at no cost to the building owner. The process may involve splitting the annual energy savings, on a 50-50 basis with the building owners, while locking the energy prices fixed with a small (e.g., less than 3%) escalation.

Many (e.g., 65%) of HVAC economizers in California may not be beneficial, while the state appears to have about 4,000 hours per year of natural fresh air conditioning. A large number (e.g., more than 90%) of HVAC systems in commercial buildings may need commissioning (e.g., similar to tuning up a car engine). HVAC systems may account for approximately 55% of energy bills of commercial buildings. HVAC optimizations may have the fastest pay back compared to other efficiency retrofits.

There are five types of efficiencies (5Es) in a retrofit building, such as: Component efficiencies (e.g., high R value windows and envelopes, LED lighting, etc.); Source efficiencies (e.g., solar electric panels and solar hot water, wind turbines, etc.); Storage efficiencies (e.g., Lithium batteries, Ice Storage, etc.); HVAC efficiencies (Also known as distribution efficiencies, e.g., efficiencies related to boiler, compressor, air delivery systems, etc.); and control and monitoring efficiencies. HVAC efficiencies and control and monitoring efficiencies may have the fastest payback time (e.g., less than 3 years) in a retrofit building.

For the purpose of U.S. tax deductions, for commercial buildings, energy savings are categorized in three major categories: HVAC and Commissioning; Lighting and Electrical; and Envelop and Fenestrations (windows). Present disclosure may relate to HVAC and commissioning portion of the tax deduction. A financing model for evaluating the cost of the retrofitting of components 122 of FIG. 1 may be provided in relation to a tax rate, based on the normalized payback time determined by using the data stored in the retrofit-cost database 280 of FIG. 2.

Existing leadership in energy and design (LEED) guidelines may be inept and inadequate for energy savings in new and retrofit buildings. LEED may be characterized as a onetime snapshot of the building for energy usage in some extreme condition. That snapshot may not be repeated in the life time of the building again. LEED may be misleading for energy Efficiency line of work and for the building owner. Therefore, energy efficiency (ee) LEED may be developed based on the disclosed technology. The eeLEED can practically replace LEED in building retrofitting projects. Commercial mortgages are normally amortized in 30 years (i.e., 360 months). Energy retrofit projects may have a payback period measured in years plus fractions of a year. So the payback could be measured in months. An eeLEED number may be defined as 360/payback period (in months), where parts and labor costs may also be included in the payback time.

The eeLEED number can have a value between 1 and 360, where 360 may represent the highest value, or the best retrofit investment with a payback time of 1 month. As the technology improves, the payback period may decrease; and therefore the reverse ratio of 360/payback can magnify a better distinction of technologies by end customers. This ratio can be used to tie the energy retrofit to an interest rate (e.g., a mortgage or cost of funds interest rate), property tax rate, and the like, as it is a function of 360 months. Equations may be developed to link eeLEED number to an effective interest rate, amortization schedule, or initial and final values, depreciation schedules, and to the property taxes. For example, Serious windows has a payback time of 3.25 years, that corresponds to an eeLEED number of 360/(3.25×12)=9.23, or an HVAC retro commissioning with auto commissioning technology, has a payback time of e.g. 4 years, which results in an eeLEED number of 360/48=7.5. Similarly, a solar photovoltaic panel with an 8 years payback period corresponds to an eeLEED number=360/(8×10)=3.75. So the energy retrofit projects with low eeLEED numbers may not have as good retrofits as compared to projects with high eeLEED numbers.

Financial models for retrofit efficiency that affect the operational expense (Op Ex) can justify or qualify retrofit efficiency in the Op Ex table rather than a line item in the capital expense (Cap Ex) tables. Retrofit efficiency can be tied up to property tax credits, or Op Ex tax credits (e.g., for small business owners as well as fortune 500 companies), and make up a vehicle for legislating it. Management may consider Op Ex more closely than other factors. So the eeLEED number can be very beneficial.

Performing retrofit projects can be based on the use of AutoCAD architectural floor plans of a structure, the structure's address in Google map, or site visit inspection reports for design, optimization, and retrofit of HVAC systems. Retrofit projects may tune up HVAC systems and the building performance while establishing critical trend data for observation and monitoring of the buildings. With regard to trending, critical sensor read-outs, for fulltime monitoring, may be used in control and commissioning of HVAC system. With the disclosed technology, buildings can be kept at or near the optimum energy usage. The retrofit projects may involve using on-demand and periodic critical measurements, and comparing them with fluid dynamic models, creating performance reports, repairing and maintenance schedules over time by observing the drift behavior of building mechanical parts.

Energy retrofits projects may be considered as financial packages regardless of the technology behind the retrofitting. Financial packages related to energy retrofit/optimisation may include e.g. 3 points, 7 points, 14 points, 21 points, and 28 point retrofit packages with 1 year, 2 years, 3 years, 5 years and 7 year paybacks, respectively. The normalized retrofit expenses and Cap Ex by 360 can be added up, and be related it to the 30 year interest rate backed by Op Ex savings in a 10 year amortization table. The 10 year savings will be distributed, for example, as follows: 33% for the vendor, 33% for the financial company and the rest for the tenant of the property.

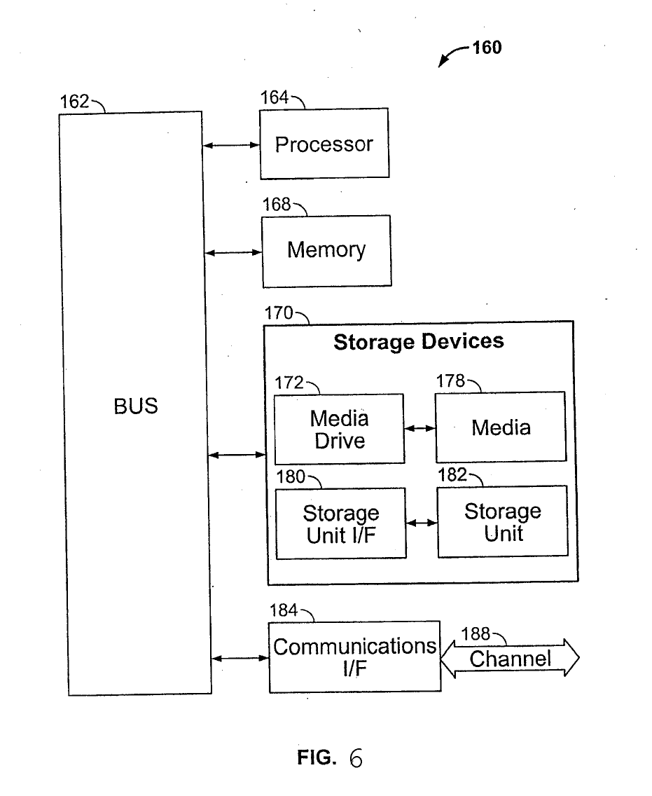

FIG. 6 shows in a block diagram relevant portions of a computing device (system) 160 in accordance with the invention which carries out the processes as described above. This is, e.g., a server platform, or computer, or similar device, or part of such a device and includes conventional hardware components executing in one embodiment software (computer code) which carries out the above examples. This code may be, e.g., in the C or C++ computer language or its functionality may be expressed in the form of firmware or hardware logic; writing such code or designing such logic would be routine in light of the above examples and logical expressions. Of course, the above examples are not limiting. Only relevant portions of this apparatus are shown for simplicity.

FIG. 6 thereby illustrates detail of a typical and conventional embodiment of computing system 160 that may be employed to implement processing functionality in embodiments of the invention. Computing systems of this type may be used in a computer server or user (client) computer or other computing device, for example. Those skilled in the relevant art will also recognize how to implement embodiments of the invention using other computer systems or architectures. Computing system 160 may represent, for example, a desktop, laptop or notebook computer, or any other type of special or general purpose computing device as may be desirable or appropriate for a given application or environment. Computing system 160 can include one or more processors, such as a processor 164. Processor 164 can be implemented using a general or special purpose processing engine such as, for example, a microprocessor, microcontroller or other control logic. In this example, processor 164 is connected to a bus 162 or other communications medium.

Computing system 160 can also include a main memory 168, such as random access memory (RAM) or other dynamic memory, for storing information and instructions to be executed by processor 164. Main memory 168 also may be used for storing temporary variables or other intermediate information during execution of instructions to be executed by processor 164. Computing system 160 may likewise include a read only memory (ROM) or other static storage device coupled to bus 162 for storing static information and instructions for processor 164.

Computing system 160 may also include information storage system 170, which may include, for example, a media drive 162 and a removable storage interface 180. The media drive 172 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 178 may include, for example, a hard disk, floppy disk, magnetic tape, optical disk, CD or DVD, or other fixed or removable medium that is read by and written to by media drive 72. As these examples illustrate, the storage media 178 may include a computer-readable storage medium having stored therein particular computer software or data.

In alternative embodiments, information storage system 170 may include other similar components for allowing computer programs or other instructions or data to be loaded into computing system 160. Such components may include, for example, a removable storage unit 182 and an interface 180, such as a program cartridge and cartridge interface, a removable memory (for example, a flash memory or other removable memory module) and memory slot, and other removable storage units 182 and interfaces 180 that allow software and data to be transferred from the removable storage unit 178 to computing system 160.

Computing system 160 can also include a communications interface 184. Communications interface 184 can be used to allow software and data to be transferred between computing system 160 and external devices. Examples of communications interface 184 can include a modem, a network interface (such as an Ethernet or other network interface card (NIC)), a communications port (such as for example, a USB port), a PCMCIA slot and card, etc. Software and data transferred via communications interface 184 are in the form of signals which can be electronic, electromagnetic, optical or other signals capable of being received by communications interface 184. These signals are provided to communications interface 184 via a channel 188. This channel 188 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 168, storage device 178, or storage unit 182. These and other forms of computer-readable media may store one or more instructions for use by processor 164, to cause the processor to perform specified operations. Such instructions, generally referred to as “computer program code” (which may be grouped in the form of computer programs or other groupings), when executed, enable the computing system 160 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 160 using, for example, removable storage drive 174, drive 172 or communications interface 184. The control logic (in this example, software instructions or computer program code), when executed by the processor 164, causes the processor 164 to perform the functions of embodiments of the invention as described herein.

The present disclosure is directed to a method and system for financial modeling of energy efficiency retrofitting cost of energy systems. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

I claim:

1. A method comprising the acts of:
receiving signals from a plurality of sensors positioned in predetermined locations of a structure to measure performance of energy consuming components of the structure;
comparing the received signals with benchmarks retrieved from a benchmark database stored on a first computer readable medium;
identifying, using results of the comparison, at least one of the components of the structure as a candidate for retrofitting; and
providing stored in a second computer readable medium a financing model for evaluating a cost of retrofitting the at least one component in relation to an interest rate, based on a payback time or rate of return determined by using data retrieved from a database.

2. The method of claim 1, further comprising generating a list of malfunctioning or under-performing ones of the components, based on the signals received from the sensors.

3. The method of claim 2, further comprising providing a maintenance schedule for the components in the list, wherein the maintenance schedule is such that operation of the structure is at an optimum energy efficiency.

4. The method of claim 1, further comprising controlling operations of the components via a plurality of control signals, whereby each component operates at a predetermined percentage of its rating while maintaining a predetermined overall efficiency of the structure.

5. The method of claim 1, wherein the structure includes at least one of a building heat ventilation and air conditioning (HVAC) system or an industrial complex, and wherein the industrial complex includes at least one of a manufacturing facility, a refinery, a data center, a power plant, or an offshore platform.

6. The method of claim 1, wherein the benchmark database comprises benchmarks relating to performance of a plurality of the components.

7. The method of claim 1, wherein the components each are a mechanical system, an electrical system, an electromechanical system, or a renewable energy conversion system.

8. The method of claim 1, further comprising providing a model for evaluating the cost of the retrofitting the at least one component in relation to a tax rate, based on the normalized payback time or rate of return determined by using the data stored in the cost database.

9. The method of claim 1, wherein the cost database comprises information relating to cost of retrofitting a plurality of the components.

10. A monitoring and evaluation system comprising:
a plurality of sensors adapted to be positioned at predetermined locations of a structure, each sensor configured to measure a parameter relating to performance of an energy consuming component of the structure;
a communication module coupled to a network and configured to receive signals from the plurality of sensors;
at least one processor;
a computer readable memory coupled to the processor, the memory configured to store:
a benchmark database configured to store benchmarks;
a comparison module, executable by the processor, configured to compare the received signals with benchmarks retrieved from a benchmark database;
an identification module, executable by the processor, configured to identify, using results of the comparison, at least one component of the structure as a candidate for retrofitting;
a cost database configured to store information relating to a retrofitting cost of a plurality of the components; and
a modeling module, executable by the processor, configured to provide a model for evaluating a cost of retrofitting the at least one component in relation to an interest rate, based on a payback time or rate of return determined by using data retrieved from a retrofit-cost database.

11. The system of claim 10, wherein the memory further stores a list generator module configured to facilitate cost savings by generating a list of malfunctioning or under-performing ones of the components, based on the received signals from the sensors.

12. The system of claim 11, wherein the memory further stores a maintenance module configured to provide a maintenance schedule for the components in the list, wherein the maintenance schedule is such that the operation of the structure is kept at an optimum energy efficiency.

13. The system of claim 10, further comprising a control module configured to control operations of the components via a plurality of local and global control signals, whereby each component operates at a predetermined percentage of its rating while maintaining a predetermined overall efficiency of the structure.

14. The system of claim 10, wherein the structure includes at least one of a building heat ventilation and air conditioning (HVAC) system, or an industrial complex, and wherein the industrial complex includes at least one of a manufacturing facility, a refinery, a power plant, or an offshore platform.

15. The system of claim 10, wherein the benchmark database is configured to store benchmarks relating to performance of a plurality of the components.

16. The system of claim 10, wherein the components each are a mechanical system, an electrical system, an electromechanical system, or a renewable energy conversion system.

17. The system of claim 10, wherein the modeling module is further configured to provide a model for evaluating the cost of retrofitting of the at least one component in relation to a tax rate, based on the normalized payback time or rate of return determined by using the data retrieved from the retrofit-cost database.

18. A monitoring and evaluation system comprising:
a communications element adapted to receive signals from a plurality of sensors positioned in predetermined locations of a structure;
a processing element;
a comparing element, executable by the processing element, which compares the received signals with benchmarks retrieved from a benchmark database;
an identifying element, executable by the processing element, which identifies, using results of the comparison, at least one component of the structure as a candidate for retrofitting, the comparing means executable by the processing element; and
a modeling element, executable by the processing element, which provides a model for evaluating a cost of retrofitting the at least one component in relation to an interest rate, based on a normalized payback time or rate of return determined by using data retrieved from a cost database.

19. The system of claim 18, further comprising a list-generating element, executable by the processing element, which facilitates related cost savings by generating a list of at least one malfunctioning or under-performing components, based on the received signals from the sensors.

20. The system of claim 19, further comprising a maintenance element, executable by the processing element, which provides a maintenance schedule for the components in the list, wherein the maintenance schedule is such that the operation of the structure is kept at an optimum energy efficiency.
